(19) United States
(12) Patent Application Publication
(10) Pub. No.: US 2015/0181831 A1
(43) Pub. Date: Jul. 2, 2015

(54) HYBRID COMPOSITE COATED ANIMAL LITTER COMPOSITIONS

(71) Applicant: Nestec SA, Vevey (CH)

(72) Inventors: Nathan Foster Huck, Jackson, MO (US); Yimin ZHANG, Ballwin, MO (US)

(21) Appl. No.: 14/579,413

(22) Filed: Dec. 22, 2014

Related U.S. Application Data
(60) Provisional application No. 61/922,164, filed on Dec. 31, 2013.

(51) Int. Cl. A01K 1/015; B05D 3/12

(52) U.S. Cl. CPC A01K 1/0154; A01K 1/0155; B05D 3/12; B05D 2601/00

(57) ABSTRACT

Animal litter compositions having a non-agglomerated, organic, coated particle are described herein. Methods of manufacturing such litter compositions are also described.

### FIELD OF THE DISCLOSURE

The present invention generally relates to animal litter compositions and methods of producing animal litter compositions.

### BACKGROUND

A clumping animal litter, as known in the industry, is a litter product in which particles clump upon contact with a liquid such as urine. Clumping litter is desirable because it allows the consumer to separate and remove urine-soaked litter granules and provides a cost savings to the consumer because the entire litter does not have to be replaced.

Traditional litters, including clumping litters, often rely heavily on inorganic materials which are relatively bulky, dense materials and thus packaged products are heavy and can be difficult for consumers to manage. Litters made primarily of organic materials, while often less dense and, therefore, lighter weight as a packaged material, often provide inferior performance, such as inferior odor control or clumping, and may promote growth of microorganisms.

### SUMMARY OF THE DISCLOSURE

Among the various aspects of the present disclosure is the provision of an animal litter composition having a relatively low density (and thus lightweight) and comprised in part of organic materials and, in preferred embodiments, in part of inorganic materials, among other beneficial properties.

Briefly, therefore, the present disclosure is directed to an animal litter composition comprising (i) a non-agglomerated particle consisting essentially of organic material (e.g., the organic material of the particle is not agglomerated or otherwise gathered into a mass or clustered with any other material); and (ii) a coating on an outer surface of the particle.

In preferred embodiments the coating comprises inorganic material that, preferably, functions as a clumping agent. In other embodiments, the coating does not function as a clumping agent.

In preferred embodiments, the organic materials consist essentially of cellulosic materials; more preferably the organic materials consist essentially of absorbent, cellulosic materials.

In a particular embodiment, the litter composition comprises a corn cob particle coated on its outer surface with sodium bentonite. In another particular embodiment, the litter composition comprises wheat middlings coated with sodium bentonite, and in yet another embodiment, the litter composition comprises pecan shell particles coated with sodium bentonite.

Another aspect of the present disclosure is directed to methods of manufacturing animal litters. One method involves (i) feeding organic particles into a coater (or other mixing apparatus); (ii) adding a liquid to the coater to create wet organic particles; and (iii) feeding bentonite having a size range of about 100 mesh to about 300 mesh into the coater to coat the wet organic particles.

Other objects and features will be in part apparent and in part pointed out hereinafter.

### BRIEF DESCRIPTION OF THE DRAWINGS

FIG. 1 shows a method of manufacturing a coated litter of the disclosure.

FIG. 2 is a table illustrating characteristics of exemplary embodiments and of a prior art litter.

### DETAILED DESCRIPTION

It must be noted that, as used in this specification and the appended claims, the singular forms “a,” “an” and “the” include plural referents unless the content clearly dictates otherwise.

Unless defined otherwise, all technical and scientific terms used herein have the same meaning as commonly understood by one of ordinary skill in the art to which the disclosure pertains. Although a number of methods and materials similar or equivalent to those described herein can be used in the practice of the present disclosure, the preferred materials and methods are described herein.

All numbers expressing quantities of ingredients, constituents, reaction conditions, and so forth used in the specification and claims are to be understood as being modified in all instances by the term “about.” Notwithstanding that the numerical ranges and parameters setting forth the broad scope of the subject matter presented herein are approximations, the numerical values set forth in the specific examples are reported as precisely as possible. All numerical values, however, inherently contain certain errors necessarily resulting from the standard deviation found in their respective testing measurements.

The term “mesh,” “U.S. sieve” or “Mesh U.S. Sieve Series” as used herein and in the appended claims is defined by ASTM E-11 U.S.A. Standard testing Sieves.

Formulations of hybrid, low density coated animal litter and methods for producing hybrid, low density coated animal litter are described. In the following description, for purposes of explanation, numerous specific details are set forth in order to provide a thorough understanding of various exemplary embodiments. It will be evident, however, to one of ordinary skill in the art that embodiments of the invention may be practiced without these specific details.

Litter Compositions

The litter compositions of the present disclosure include coated, non-agglomerated, organic particles. In preferred embodiments, the coating comprises inorganic materials and the litters are therefore a hybrid combination of organic and inorganic materials. In particularly preferred embodiments, the coating comprises inorganic, clumping materials. However, other coatings, such as coatings consisting essentially of organic or non-clumping materials, may be used in other embodiments. In yet other embodiments, combinations of organic and inorganic materials, or combinations of clumping and non-clumping materials, may be used as a coating material for the organic particles.

In certain embodiments, the particles consist essentially of absorbent, cellulosic material and the coating consists essentially of sodium bentonite. In one embodiment, the particles are non-agglomerated particles comprising corn cob particles. In another embodiment, the particles are non-agglomerated particles comprising wheat middlings. Other embodiments include, by way of example, non-agglomerated particles comprising spent coffee grounds, pecan shell granules, walnut shell granules, almond shell granules, cedar wood chips, pine wood chips, other plant particulates, or combinations thereof. In preferred embodiments, the core materials are absorbent cellulosic materials that are relatively robust, e.g., that maintain structural integrity over time.

Particles of organic material selected for of litter compositions of the present disclosure can be defined by their particle size and particle size distribution. A range of particle sizes is preferred for the hybrid, low density coated litters described herein. In one embodiment, the organic material consists primarily of particles sized in the range of U.S. sieve −6 to U.S. sieve 50 (such that the material will pass through a U.S. 6 sieve but will be retained by a U.S. 50 sieve). In another embodiment, the organic material consists primarily of particles sized in the range of U.S. sieve −8 to U.S. sieve 50; in yet another embodiment, the organic material consists primarily of particles sized in the range of U.S. sieve −10 to U.S. sieve 40. A further embodiment comprises organic material consisting primarily of particles that range in size from U.S. sieve −10 to U.S. sieve 30. Other embodiments include those in which the organic material consists primarily of particles that range in size from U.S. sieve −12 to U.S. sieve 20; from U.S. sieve −8 to U.S. sieve 20; from U.S. sieve −8 to U.S. sieve 30; from U.S. sieve −6 to U.S. sieve 30; from U.S. sieve −6 to U.S. sieve 40; from −10 to 14 U.S. sieve, and from U.S. sieve −10 to U.S. sieve 20. Preferably, the organic material particles are not evenly distributed within the size range.

The range of particle sizes selected for organic materials of litter compositions of the present invention may be based at least in part on the particular organic material or materials selected for the litter. For example, in one embodiment, the organic material consists primarily of corn cob particles sized in the range of U.S. sieve −10 to 40. In another example embodiment, the organic material consists primarily of corn cob particles sized in the range of U.S. sieve −10 to 14 U.S. sieve. In yet another example embodiment, the organic material consists primarily of nut shell particles sized in the range of U.S. sieve −12 to 20. A further embodiment includes organic materials consisting primarily of wheat middlings sized in the range of U.S. sieve −8 to 20. Combinations of organic materials may be used. Accordingly, additional examples include litter in which the organic materials consist primarily of: a mixture of corn cob particles sized in the range of about U.S. sieve −10 to 40 and wheat middlings sized in the range of about U.S. sieve −8 to 20; a mixture of corn cob particles sized in the range of about U.S. sieve −10 to 14 and wheat middlings sized in the range of U.S. sieve −8 to 20; a mixture of corn cob particles sized in the range of about U.S. sieve −10 to 40 and nut shell particles sized in the range of about U.S. sieve −12 to 20. Other combinations may be used.

Organic materials of litter compositions of the present disclosure can be further defined by their bulk density. In certain embodiments, the bulk density of the organic materials ranges between about 30 and about 40 lb/ft³; organic materials with other bulk densities or bulk density ranges may be used in other embodiments.

Organic materials may also be defined by their absorption by volume percentages. In certain embodiments, the absorption by volume percentages of the organic materials ranges between about 20% and about 70% (e.g., about 20%, 25%, 30%, 35%, 40%, 45%, 50%, 55%, 60%, 65%, or 70%). when measured using the following equipment and according to the following process:

Equipment

Equipment includes: (a) a sample splitter appropriate to product sizing; (b) a bulk density apparatus (800 284-5779 Seedburo; part number 151 Filling Hopper complete with 64P Pan); (c) a straight-edge such as a 12 inch ruler; (d) a balance (accurate to 0.1 g); (e) a sorption funnel; (f) a ring support (4″) and support stand (24″); (g) a graduated cylinder, 250 ml; (h) an interval timer; and (i) a specimen cup with a volume of approximately 150 ml.

Process

1. Determine the volume of the specimen cup as follows: (a) tare the specimen cup on the balance and fill with water to the top edge; (b) record the mass of water in grams; since 1 gram of water is approximately 1 ml in volume, this will be volume of specimen cup in ml; and (c) pour out the water and completely dry inside and outside of the cup.

2. Set up the hopper and stand assembly. Close the sliding gate at the bottom of the hopper.

3. Set up the ring support and stand, positioning the sorption funnel above the graduated cylinder so that the hose end extends ½″ to 1″ into the cylinder. Seal the bottom of the funnel.

4. Obtain a representative portion of sample and split to size enough to fill about % of the hopper of the bulk density apparatus. Pour the split sample into the hopper.

5. Tare the specimen cup on the balance.

6. Position the specimen cup under the center of the hopper 2^{3/4} inches below the gate opening. Open the hopper gate quickly. Allow the sample to fill the cup and overflow into the pan below. Do not vibrate the cup or close the gate before all the sample has flowed out of the hopper.

7. Level the material in the specimen cup to the top edge of the cup using a straight edge and sawing motion. Do not vibrate or compact the sample prior to leveling.

8. Weigh the contents of the cup to the nearest 0.1 grams and record. This will be the mass of the sample in grams. The volume of the sample is equivalent to the volume of the specimen cup.

9. Pour the sample into the sorption funnel.

10. Tare the 250 ml graduated cylinder on the balance, and then fill it with water from a cold tap to approximate 250 ml. Weigh the water in the cylinder and record the water mass in grams. This is the initial water weight in grams (Wᵢₙᵢₜᵢₐₗ) as well as the initial water volume in ml (Vᵢₙᵢₜᵢₐₗ).

11. Add the water to the sample in funnel. Let soak for 10 minutes.

12. Tare the 250 ml Graduated Cylinder on the Balance again, and then place it under the Funnel drain hose.

13. After 10 minutes of soaking, release the clamp and allow the water in the Funnel to drain into the Cylinder for 5 minutes.

14. Using fingers, squeeze and release drain hose to free any water that may be trapped.

15. Place the graduated cylinder with water on the balance, record the weight of water drained from funnel in grams. This is the final water weight in grams (W_{final}) as well as final water volume in ml (V_{final}).

Calculation of Percentage Absorption by Volume

Volume of water absorbed(ml)=Vᵢₙᵢₜᵢₐₗ(Initial water volume)−V_{final}(Final water volume)

$$\% Absorption by volume = \frac{Volume of water absorbed ( ml )}{Volume of specimen cup ( ml )} \times 100$$

Percentage absorption by weight may be similarly calculated as follows:

Absorption by Weight of water absorbed(g)=Wᵢₙᵢₜᵢₐₗ(Initial water initial water weight)−W_{final}(Final water weight)

$$\% Absorption by weight = \frac{Weight of water absorbed ( g )}{Weight of sample in specimen cup ( g )} \times 100$$

In litter compositions of the present disclosure, the core organic particles are coated. In preferred embodiments, the coating comprises a clumping agent; i.e., an agent which when wetted results in the binding of adjacent particles. Representative clumping agents include, for example, bentonite (such as sodium bentonite), guar gums, starches, xanthan gums, gum Arabic, gum acacia, silica gel, and other minerals, and mixtures a mixture thereof. In one embodiment, the clumping agent comprises bentonite.

In one preferred embodiment, the clumping agent comprises sodium bentonite. Sodium bentonite is described in the industry as a “swelling” clay because particles of sodium bentonite enlarge in size and volume when they absorb moisture. In addition, sodium bentonite particles exhibit gel-like qualities when wet that promote clumping of the sodium bentonite particles when liquid (such as urine) is applied. In another embodiment, the clumping agent comprises a mixture of sodium bentonite and guar gum.

Where sodium bentonite is employed as or in the clumping agent, the bulk density of the bentonite is typically in the range of 600 to 1125 kg/m³ (e.g., 600 kg/m³, 700 kg/m³, 800 kg/m³, 900 kg/m³, 1000 kg/m³, or 1100 kg/m³). In one particular embodiment, for example, the bulk density of the sodium bentonite is about 1125 kg/m³ (about 70 lb/ft³).

In one embodiment, the moisture percentage of the sodium bentonite of the low density litter is between about 6% and 7% (e.g., 6.1%, 6.2%, 6.3%, 6.4%, 6.5%, 6.6%, 6.7%, 6.8%, or 6.9%). In a particular embodiment, the moisture percentage of the sodium bentonite is about 6.24%.

The bentonite of the low density coated litter is preferably provided as a powder or “fines” with a size range of 100 to 300 mesh. In an example embodiment, sodium bentonite particles are employed at about 200 mesh.

Methods of Preparing Litter Compositions

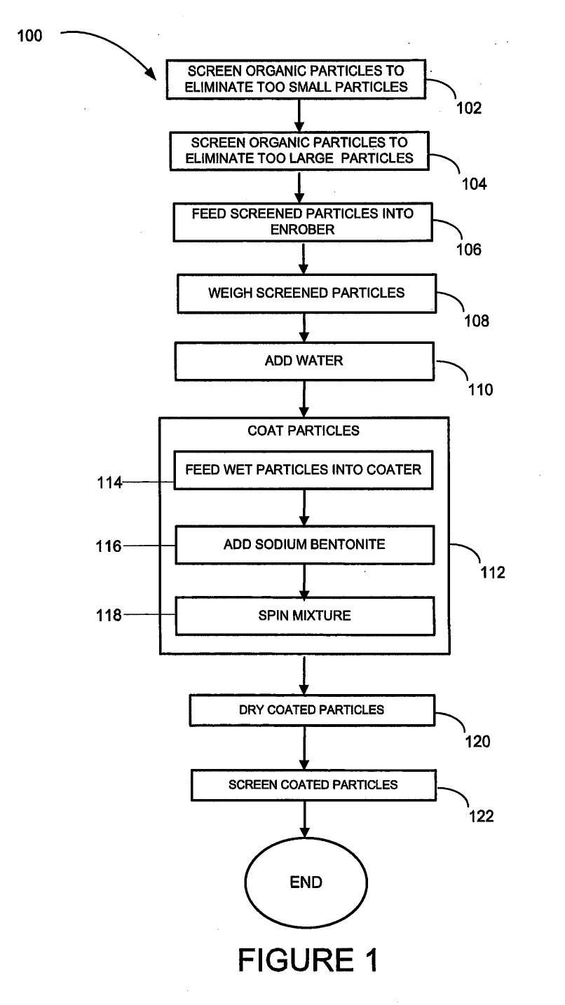

In general, methods for preparing litter compositions in accordance with the disclosure involve coating an organic particle; preferably, with a clumping agent. In the embodiment illustrated in FIG. 1, for example, hybrid, low density litter is produced by a method 100 employing the steps described below. In other embodiments, hybrid, low density litter is produced by a method employing one or more of the steps of method 100.

In step 102, materials selected for the organic particles of the litter are screened to eliminate particles smaller than the range of particle sizes selected for the particular embodiment of litter. For example, organic particles may be screened to eliminate particles smaller than about 50 U.S. sieve; more preferably, organic particles may be screened to eliminate particles smaller than about 40 U.S. sieve. In other embodiments, organic particles are screened to eliminate particles smaller than about 30 U.S. sieve, smaller than about 20 U.S. sieve, or smaller than about 14 U.S. sieve. Commercially available shaker screens may be utilized, or other appropriate means may be employed to eliminate the desired sizes of particles.

In step 104, materials selected for the organic particles of the litter are screened to eliminate particles larger than the range of particle sizes selected for the particular embodiment of litter. For example, organic particles may be screened to eliminate particles larger than about 6 U.S. sieve; more preferably, organic particles may be screened to eliminate those larger than about 8 U.S. sieve. In other embodiments, organic particles are screened to eliminate particles larger than about 10 U.S. sieve or larger than about 12 U.S. sieve. Again, commercially available shaker screens, or other appropriate means, may be utilized.

The sized organic particles are placed in an enrobing machine at step 106, to agitate the particles. This assists in the reduction of fines which, in turn, aids in dust abatement. In the example embodiment of method 100, organic particles are weighed at step 108 before or as they enter the enrober and the particles are sprayed with water 110.

The amount of water added (which, as discussed below, may be added in the enrober, in the coater, or both) generally depends, at least in part, upon the weight of the coating material that will be applied in the coating step 116 (which, as described below, may be determined by the volume of organic materials to which the coating will be applied). In one embodiment, for example, the weight of water added in accordance with a method 100 of preparing litter compositions is between about 10 and 100 percent of the weight of the coating material (e.g., about 10%, 15%, 20%, 25%, 30%, 35%, 40%, 45%, 50%, 55%, 60%, 65%, 70%, 75%, 80%, 85%, 90%, 95%, or 100%). In another embodiment, for example, the weight of water added is between about 15 percent and 45 percent of the weight of the coating material (e.g., about 15%, 20%, 25%, 30%, 35%, 40%, or 45%). In one particular embodiment, for example, the weight of water added is about one-third of the weight of the coating material.

In an alternative embodiment, water may be added at step 110 (or, in another embodiment, in the coater, or, in yet another embodiment, partially at step 110 and partially in the coater) as discussed in a quantity appropriate to achieve a particular target moisture content. In this embodiment, step 110 further includes the steps of identifying the starting moisture content of the organic particles, identifying a target moisture content at the end of step 110, and calculating the quantity of water to be added to achieve the target moisture content based on the identified starting moisture content and identified target moisture content. In one embodiment, water is added in a quantity appropriate to achieve a target moisture content of about 5% to 60% (e.g., about 5%, 10%, 15%, 20%, 25%, 30%, 35%, 40%, 45%, 50%, 55%, or 60%). In another embodiment, water is added in a quantity appropriate to achieve a target moisture content of about 50% to 60% (e.g., about 50%, 53%, 55%, 58%, or 60%). In yet another embodiment, water is added in a quantity appropriate to achieve a target moisture content of about 30% to 40% (e.g., about 30%, 33%, 35%, 37%, or 40%). For example, in a particular embodiment, the organic particles are corn cob particles with an initial moisture content of 8%, the target moisture content upon completion of step 110 is 58%, and, therefore, a quantity of water that weighs 50% of the weight of the corn cob particles is added to the corn cob particles.

Water is preferably added at a flow rate that permits application of the water to the particles evenly and such that the particles achieve a substantially uniform moisture content. Within the bounds of those parameters, a faster flow rate is generally preferred.

At step 112, organic particles are coated (e.g., with sodium bentonite) in a coater. By way of example, centrifugal coating methods can be employed. For instance, a batch of organic particles may be fed into the coater as it rotates 114.

In some embodiments, water may be added to the coater while the coater is spinning. The amount of water added to the coater may be some portion or all of the total amount of water selected or otherwise identified for use in formation of the litter particles, determined as described above. Thus, having identified the total amount of water to be added, that quantity of water can be added in the enrober, in the coater, or partially in the enrober and partially in the coater.

For example, in one embodiment, approximately seventy-five percent of the total water to be added is added in the enrober and approximately twenty-five percent of such water is added in the coater. Other ratios may be used such as 95% enrober/5% coater; 80% enrober/20% coater; 70% enrober/30% coater; 50% enrober/50% coater; 25% enrober/75% coater; and 10% enrober/90% coater.

At step 116, the coating material (e.g., a clumping agent, such as sodium bentonite) is metered into the coater. In general, the quantity of coating material added into the coater is based on the volume of organic particles. In one embodiment, for example, between about 4 and about 30 pounds of sodium bentonite are added per cubic foot of organic particles (e.g., about 4 pounds, 5 pounds, 6 pounds, 7 pounds, 8 pounds, 9 pounds, 10 pounds, 11 pounds, 12 pounds, 13 pounds, 14 pounds, 15 pounds, 16 pounds, 17 pounds, 18 pound, 19 pounds, 20 pounds, 21 pounds, 22 pounds, 23 pounds, 24 pounds, 25 pounds, 26 pounds, 27 pounds, 28 pounds, 29 pounds or 30 pounds). In another embodiment, for example, between about 15 and about 20 pounds of sodium bentonite are added per cubic foot of organic material (e.g., about 15 pounds, 16 pounds, 17 pounds, 18 pounds, 19 pounds, or 20 pounds). In yet another embodiment, about 18 pounds of sodium bentonite is added per cubic foot of organic particles and the organic particles consist primarily of corn cob particles or almond shell grit. Other relative quantities of coating material may be used. Relative quantities of coating material and organic particles may be identified by weight of coating material and organic particles. For example, in one embodiment, the weight of sodium bentonite is about equal to the weight of organic particles added to the coater.

Other coating materials, such as guar gum, may be included in the coater in addition to or instead of a bentonite-based clumping agent. When used in addition, such materials may be added as a mixture, along with the bentonite, or they may be added in a separate step.

In one example, a clumping agent (e.g., a bentonite, such as sodium bentonite) is heated prior to or as it is fed into the coater to increase its gelling efficiency.

As the bentonite (or other coating material) is metered into the chamber of the coater, it combines with the wet, spinning organic particles and forms a coating on the organic particles.

In one example, the coating material added at step 116 is added over about 30 seconds. In other examples, coating material is added over about 15 seconds, 1 minute, 1.5 minutes, or 2 minutes. Other addition times may be employed in other embodiments.

In step 118, the mixture spins for an additional period of time after the coating material has been added. For example, the mixture may spin for an additional 5 seconds, 10 seconds, 20 seconds, or 30 seconds. Other post-coating material spinning times may be employed in other embodiments, or the post-coating spinning time may be about 0 seconds.

An optional misting step may be employed during or following step 118, in which the coated organic particles are misted or sprayed with a light application of water. If this optional misting step is employed, then the quantity of water added in the misting step may be included in calculating the total quantity of water to be added during the production of the coated organic litter particles. The misting step may be employed in embodiments in which water is also added in the enrober, in the coater, or in both the enrober and the coater.

For example, in one embodiment, approximately eighty-five percent of the total water to be added in the production of coated organic litter particles is added in the enrober and approximately fifteen percent of such water is added in a misting step. In another embodiment, approximately eighty-five percent of such water is added in the coater and approximately fifteen percent of such water is added in a misting step. In yet another embodiment, approximately twenty percent of such water is added in the enrober, approximately seventy-five percent of such water is added in the coater, and approximately five percent of such water is added in a misting step. Non-limiting examples of other ratios that may be used are: 90% enrober/10% misting step; 40% enrober/40% coater/10% misting step; 70% enrober/20% coater/10% misting step; 50% enrober/35% coater/15% misting step; 15% enrober/75% coater/10% misting step; and 10% enrober/85% coater/5% misting step. Preferably, no more than 15% of the total water to be added is added at the misting step.

In addition to or instead of coaters, other mixing apparatuses or equipment suitable for combining organic core particles with coating materials and water, such as blenders or mixers, may be used in preparing coated particles of litters of the present disclosure.

At step 120, the coated particles are transferred to a dryer. Drying preferably removes moisture from the coated particle without substantially removing the coating or substantially damaging the finished product. A fluidized bed dryer is utilized in certain embodiments. Typically, the coated particles are dried to have a moisture content ranging from about 5% to about 15% (e.g., about 5%, about 7%, about 9%, about 11%, about 13%, or about 15%). In another embodiment, for example, the coated particles are dried to a moisture content ranging from about 7% to about 10% (e.g., about 7%, about 8%, about 9%, or about 10%). In one particular embodiment, for example, the final moisture content of the coated litter product is about 8%. In another particular embodiment, the coated particles are dried to a moisture level sufficient to achieve a relatively uniform appearance of the coated particles.

At step 122, another screening process takes place. A vibratory screener may be used to remove coated particles larger than a mesh size of about U.S. sieve 6. In another embodiment, particles larger than a mesh size of about U.S. sieve 8 are removed. Any excess coated particles separated in the screening process may be, for example, ground and added to other litter products or used in other odor or moisture control products.

Various additives may be optionally applied. Additives may include, for instance, an odor control agent(s), a fragrance(s), an anti-microbial agent(s), an anti-sticking agent(s), an agent(s) for controlling pH, a powder(s) for coloring, dyes, a coloring agent(s) and/or colored particles, a de-dusting agent(s), a disinfectant(s), or combinations thereof.

Other materials, such as uncoated organic particles, non-swelling clay particles, or other organic or inorganic materials may be combined with coated organic particles to create a blended litter product.

Various characteristics of coated litter products of the invention represent significant improvements over existing litter products.

By way of example, the densities of coated litter compositions of the disclosure are relatively low, compared to other litter products. Typically, for example, the density of the coated litter product is between about 35 and 50 lb/ft³. In one embodiment, the density of the coated litter product is between about 37 and 46 lb/ft³ (e.g., about 37 lb/ft³, 38 lb/ft³, 39 lb/ft³, 40 lb/ft³, 41 lb/ft³, 42 lb/ft³, 43 lb/ft³, 44 lb/ft³, 45 lb/ft³, 46 lb/ft³, or 47 lb/ft³). In one particular embodiment, the density of the coated litter product is about 38 lb/ft³. In another particular embodiment, the density of the coated litter product is about 45 lb/ft³.

Litter compositions of the present disclosure offer significant advantages over traditional litters. In comparison to traditional clay litters, litter compositions of the present disclosure permit use of organic materials in lieu of a significant portion of the clay used in such traditional clay litters. In addition to reducing the amount of clay (and, therefore, potentially reducing the amount of the clay dust generated by the litter) and facilitating a lower density, such litters provide a use for agricultural by-product materials, such as corn cobs, nut shells, spent coffee grounds, wheat middlings, bark, and other agricultural by-products. In comparison to traditional low density litters made almost entirely of organic materials, use of inorganic materials for the coating of the litter products of the present disclosure (e.g., bentonite) may inhibit growth of microorganisms and provide superior odor control. As a further benefit, in comparison to more homogeneous litter mixtures, clumping litters of the present disclosure may provide better clump visibility because some portion of the coating may be displaced when a liquid contacts the litter, revealing a core of a different color or texture.

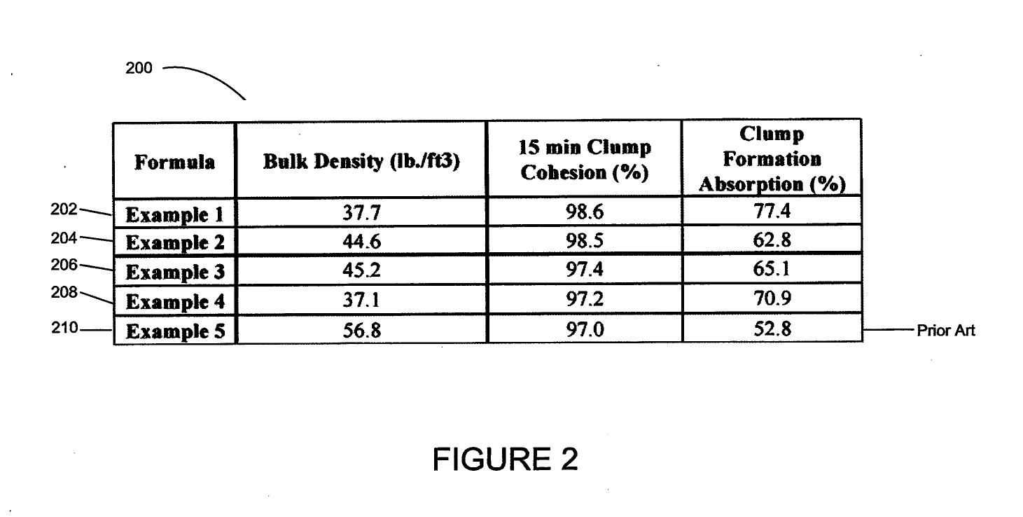

The advantages achieved by using organic materials in litters of the present disclosure are not offset by diminished performance of the litter. As illustrated by chart 200 of FIG. 2, in certain example embodiments of coated litter products of the present disclosure 202, 204, 206 the clump cohesion percentage and clump formation absorption percentage meets or exceeds the clump cohesion percentage and clump formation absorption percentage characteristics of existing clay litters 208. In one example embodiment, the clump cohesion percentage (measured in accordance with the process described below) is at least 50% (e.g., at least 50%, 55%, 60%, 65%, 70%, 75%, 80%, 85%, 90%, or 95%). In another example embodiment, the clump cohesion percentage is at least 90% (e.g., at least 90%, 92%, 94%, 96%, or 98%). In yet another example embodiment, the clump cohesion percentage (measured in accordance with the process described below) is at least 95%. In a further example embodiment, the clump cohesion percentage is at least 97%.

In an example embodiment, the clump formation absorption percentage is at least 50% (e.g., at least 50%, 55%, 60%, 65%, 70%, or 75%). In another example embodiment, the clump formation absorption percentage is at least 60% (e.g., at least 60%, 65%, 70%, or 75%). In yet another example embodiment, the clump formation absorption percentage is at least 70% (e.g., at least 70% or 75%).

The Table 200 provided in FIG. 2 also illustrates densities of coated litter products of example embodiments of the present disclosure 202, 204, 206, 208 compared to a conventional clay scooping litter 210. Use of organic material, for example, which is naturally lightweight and that is not agglomerated, crushed, extruded, or otherwise altered in a manner that increases its density, contributes to the desirable low density of the coated litter products of the invention and offers significant improvements over prior art litters.

In general, the organic particles are substantially coated with the clumping agent. In one embodiment, for example, the particles are more than 75% coated. In other embodiments, for example, the particles are more than 85%, more than 95%, or more than 99% coated. Preferably, the coating material wholly surrounds or enrobes the particles.

In some embodiments, coated organic particles of litters of the present disclosure may be sized primarily in the range of about U.S. sieve −8 to 30. In other embodiments, coated organic particles of litters of the present disclosure may be sized primarily in the range of about U.S. sieve −8 to 20. Other size ranges may be employed in other embodiments.

### EXAMPLES

The following non-limiting examples are provided to further illustrate the present invention. It should be appreciated by those of skill in the art that the techniques disclosed in the examples that follow represent approaches the inventors have found function well in the practice of the invention, and thus can be considered to constitute examples of modes for its practice. However, in light of the present disclosure, those of skill in the art should appreciate that many changes can be made in the specific embodiments that are disclosed and still obtain a like or similar result without departing from the spirit and scope of the invention.

### Example 1

### Scale Litter Formation Using Corn Cob Particles as the Organic Material

1. 4.0 lbs. of corn cob, with a particle size range of −10 to 40 U.S. sieve and an 8.0% moisture content, was mixed with 2.0 lbs. of water uniformly, forming 6.0 lbs. of moistened corn cob granules.

2. The moistened granules were added to a spinning (275 RPM), batch-type agricultural seed coater (Cimbria Heid, Centri Coater CC10), followed by the addition of 3.45 lbs. of sodium bentonite powder (200 U.S. sieve mesh) over a 30 second time period.

3. The mixture was allowed to continue to spin for 10 seconds.

4. The discharge port of the coater was then opened, and the discharged material collected. The collected material weighed about 9.45 lbs.

5. The total discharged material was then dried using a fluid bed dryer (Carrier) to a final moisture content of 8.0%, which resulted in a final product weight of 7.45 lbs.

### Example 2

### Scale Litter Formation Using Wheat Middlings as the Organic Material

Example 1 was repeated, with 4.0 lbs. of wheat middlings sized in the range of −8 U.S. sieve to 20 U.S. sieve instead of the corn cob particles. As in Example 1, 2.0 pounds of water and 3.45 pounds of bentonite power were used in litter formation. The final product weight, after drying to a final moisture content of 8.0%, was 7.45 lbs.

### Example 3

### Scale Litter Formation Using Pecan Shell Particles as the Organic Material

Example 1 was repeated, with 3.5 lbs. of pecan shell granules sized in the range of −8 U.S. sieve mesh to 20 U.S. sieve mesh instead of the corn cob. As in Example 1, 2.0 pounds of water and 3.45 pounds of bentonite power were used in litter formation. The final product weight, after drying to a final moisture content of 8.0%, was 6.95 lbs.

### Example 4

### Scale Litter Formation Using Almond Shell Particles as the Organic Material

Litter was formed according to the method described in Example 1 using 3.0 lbs. of almond shell granules sized in the range of −8 U.S. sieve mesh to 16 U.S. sieve mesh instead of the corn cob, along with 1.0 pound of water and 2.0 pounds of bentonite power. The final product weight, after drying to a final moisture content of 8.0%, was 5 lbs.

### Example 5 Scale Litter Formation—Clay Litter Control

To create a clay litter control, 10.0 lbs. of agglomerated non swelling clay particles with a moisture content of about 28% and sized in the range of −6 U.S. sieve mesh to 50 U.S. sieve mesh was combined with 3.45 pounds of bentonite power according to the method described in Example 1. After drying to a final moisture content of 8.0%, total product weight was 11.45 lbs. The litter created in this example was used as the existing litter for purposes of table 200 of FIG. 2.

### Example 6

### Bulk Density Measurement

The bulk density of Examples 1-5 was measured using a filling hopper (Seedburo Filling Hopper And Stand with a 1¼ inch diameter opening with a capacity of about 2 dry pints), stand, and pint sized sample cup according to the procedure below:

1. The litter was poured into the filling hopper until it was full.

2. Next, the empty pint cup was placed on a balance and the balance was zeroed.

3. The cup was then placed beneath the filling hopper. The distance between the filling hopper discharge, and the top edge of the cup was set at 2 inches.

4. The filling hopper discharge slide was then opened to allow product to fall into the empty sample cup. Litter was allowed to flow until the cup was full, and then for an additional 1 to 2 seconds of overflow.

5. A straight edge was then used to remove excess product from the top of the cup; leveling the cup contents with the rim of the cup.

6. The cup with litter was then returned to the balance and the weight of the litter recorded.

7. Steps 1-6 were repeated three times.

8. Mass value was converted to pounds per cubic foot (lb/ft³) using the conversion factor 1 gram per dry pint (g/dry-pt) equals 0.113358 lb/ft³.

9. The average bulk densities were calculated and are shown in Table 200 of FIG. 2. Referring to the table, it is clear that the Examples 1-4 of the invention 202, 204, 206, 208 were significantly less dense than Example 5, a conventional clay scooping litter 210.

### Example 7

### Clump Formation and Cohesiveness

The ability of the litter to absorb urine and form clumps is a key performance measure for clumping litters. The clump formation absorption percentages and clump cohesiveness of Examples 1-5 were examined according to the procedure below:

1. An 8″ diameter sieve with ¾″ mesh was stacked on top of a sieve pan and placed on the bottom of a support stand.

2. A trap door assembly was attached to the support stand and positioned ten inches above ¾″ sieve.

3. A representative sample of the material described in Example 1 was added to a litter testing pan. The depth of material was three inches.

4. A self-leveling 25 ml burette was positioned on a support stand three inches above the litter surface. This setup was used to dispense 25 ml aliquots of a 3.0% saline solution to the litter surface, forming a clump in the litter. This process was repeated in a variety of location of the litter pan until the desired number of clumps was created. Locations were selected to avoid overlapping with previously formed clumps.

5. At the end of 15 minutes, a clump was removed from the litter, and its mass recorded as W1.

6. The clump was then centered on the trap door mechanism assembled in step 2.

7. Next the lever was actuated to release the trap door, allowing the clump to fall onto the ¾″ test sieve.

8. The clump was carefully removed from the screen in a manner which allowed loose material to fall free of the clump, but not in a manner which caused additional damage to the clump. (If the clump broke into pieces, largest piece retained on the ¾″ screen was selected. If nothing is retained on the screen, the result is zero (0) weight).

9. The clump or largest piece was weighed and the mass recorded as W2.

10. This procedure was repeated with litters from Examples 2, 3, 4, and 5.

11. The clump formation absorption was calculated according to the following formula:

Clump Formation Absorption(%)=(Mass of Liquid Added/(W1−Mass of Liquid Added))×100]

in which the Mass of Liquid Added was calculated by multiplying the quantity of liquid (25 ml) by its density.

12. The mean clump formation absorption percentage of all clumps were calculated, for the litters created in Examples 1-5, and are shown on Table 200 of FIG. 2 under the heading Clump Formation Absorption (%).

13. The Percentage of Cohesion value was calculated using the following formula:

Percentage of Cohesion=[W2(final weight)/W1(initial weight)]×100

14. The Percentage of Cohesion values for all clumps were averaged and the results are illustrated in Table 200 of FIG. 2 under the heading 15 min Clump Cohesion (%).

Referring to Table 200, it is clear that the Examples formed clumps when encountering the applied liquid, and Examples 1-4 of the invention (litters comprising corn cob 202, wheat middlings 204, pecan shell 206, and almond shell 208, respectively) had higher liquid absorption capacities (clump formation absorption percentages) than that of the control litter 210. Furthermore, it is clear from Table 200 that the Percentage of Cohesion values (15 min clump cohesion percentages) for Examples 1-4 202, 204, 206, 208 of the invention were comparable to that of a conventional clay scooping litter 210.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. An animal litter composition comprising (i) a plurality of non-agglomerated organic particles selected from the group consisting of corn cob particles, wheat middlings, almond shell granules, and pecan shell granules; and (ii) a coating on an outer surface of the particles, the coating comprising bentonite.

2. The composition of claim 1 wherein the non-agglomerated particles are corn cob particles.

3. The composition of claim 1 wherein the coating comprises sodium bentonite.

4. The composition of claim 1 wherein the non-agglomerated particles have a size range of about U.S. sieve −6 to U.S. sieve 50.

5. The composition of claim 1 wherein the non-agglomerated particles have a size range of about U.S. sieve −10 to U.S. sieve 40.

6. The composition of claim 2 wherein the non-agglomerated particles have a size range of about U.S. sieve −10 to U.S. sieve 14.

7. The composition of claim 1 wherein the litter composition has a moisture content in the range of about 5 percent to about 15 percent.

8. The composition of claim 1 wherein the litter composition has a clump formation absorption percentage of at least 50 percent.

9. The composition of claim 1 wherein the litter composition has a clump cohesion percentage of at least 75 percent.

10. The composition of claim 3 wherein the particles are substantially coated with sodium bentonite.

11. A method of manufacturing an animal litter composition comprising:
(i) mixing non-agglomerated organic particles and a liquid to create wet organic particles;
(ii) feeding the wet organic particles into a mixing apparatus; and
(iii) feeding bentonite having a size range of about 100 mesh to about 300 mesh into the mixing apparatus to coat the wet organic particles.

12. The method of claim 11 further comprising: (iv) drying the coated particles to a moisture content in the range of 5% to 15%.

13. The method of claim 11 wherein the non-agglomerated particles are selected from the group consisting of corn cob particles, wheat middlings, pecan shell granules, almond shell granules, walnut shell granules, wood particles, soybean hull particles, and cotton seed hull particles.

14. The method of claim 11 wherein the coating comprises sodium bentonite.

15. The method of claim 13 wherein the non-agglomerated particles have a size range of about U.S. sieve −6 to U.S. sieve 50.

16. The method of claim 13 wherein the non-agglomerated particles are corn cob particles have a size range of about U.S. sieve −10 to U.S. sieve 40.

17. The method of claim 13 wherein the non-agglomerated particles are corn cob particles have a size range of about U.S. sieve −10 to U.S. sieve 14.

18. The method of claim 11 wherein the litter composition has a clump formation absorption percentage of at least 50 percent.

19. The method of claim 11 wherein the litter composition has a clump cohesion percentage of at least 50 percent.

20. The method of claim 11 wherein the particles are substantially coated with sodium bentonite.

21. An animal litter composition comprising (i) a plurality of non-agglomerated corn cob particles having a size range of about U.S. sieve −8 to U.S. sieve 40; (ii) a sodium bentonite coating on an outer surface of the particles, wherein the particles are more than about 50 percent coated with the sodium bentonite; and (iii) wherein the litter composition has a clump formation absorption percentage of at least 50 percent and a clump cohesion percentage of at least 75 percent.

22. The animal litter composition of claim 21 wherein the plurality of non-agglomerated corn cob particles have a size range of about U.S. sieve −8 to U.S. sieve 20.

23. The animal litter composition of claim 21 wherein the plurality of non-agglomerated corn cob particles have a size range of about U.S. sieve −8 to U.S. sieve 14.

24. The animal litter composition of claim 21 wherein the particles are more than about 75 percent coated with the sodium bentonite.

25. The animal litter composition of claim 21 wherein the particles are more than about 85 percent coated with the sodium bentonite.
